(19) United States
(12) Patent Application Publication
(10) Pub. No.: US 2026/0044310 A1
(43) Pub. Date: Feb. 12, 2026

(54) CALCULATION CIRCUIT, MEMORY DEVICE INCLUDING THE CALCULATION CIRCUIT, AND CALCULATION METHOD

(71) Applicant: Samsung Electronics Co., Ltd., Suwon-si (KR)

(72) Inventors: Won Tak HAN, Suwon-si (KR); Shin Haeng KANG, Suwon-si (KR); Kyo Min SOHN, Suwon-si (KR)

(73) Assignee: Samsung Electronics Co., Ltd., Suwon-si (KR)

(21) Appl. No.: 19/065,299

(22) Filed: Feb. 27, 2025

(30) Foreign Application Priority Data
Aug. 6, 2024 (KR) 10-2024-0104509

(51) Int. Cl. G06F 5/01; G06F 7/544

(52) U.S. Cl. CPC G06F 5/012; G06F 7/5443

(57) ABSTRACT

A calculation circuit, a memory device including the calculation circuit, and a calculation method are provided. The calculation circuit comprises an input allocator receiving and dividing n-bit input data (where n is a natural number equal to or greater than 2) into a plurality of operation elements based on a data type of the input data, an adder tree performing a multiplication operation between the operation elements, and an accumulator generating a first output value by adding an output value of the adder tree to a value stored in an accumulation register, wherein the first output value includes a sign bit and data bits, and the accumulator includes a first lightweight normalizer that performs bit shifting on the first output value by comparing a value of the sign bit with values of m bits (where m is a natural number) among the data bits.

### CROSS-REFERENCE TO RELATED APPLICATION

This application claims priority from Korean Patent Application No. 10-2024-0104509 filed on Aug. 6, 2024 in the Korean Intellectual Property Office, and all the benefits accruing therefrom under 35 U.S. C. 119, the contents of which in its entirety are herein incorporated by reference.

### BACKGROUND

Some example embodiments relate to a calculation circuit, a memory device including the calculation circuit, and/or a calculation method.

High-performance applications are data-intensive and compute-intensive. To perform inference more efficiently in data-intensive deep neural networks, a computing system with large-scale computation and memory capabilities is desirable.

Processing-in-memory (PIM)-type memory devices are being developed to perform some of the computational operations of a computing system through internal processing. Through PIM computations, the computational load of the computing system can be reduced.

Such PIM computations need to support computations for various data types, such as floating point (FP)-type data and integer (INT)-type data, and performing these computations within a short period is also desirable. Therefore, research is actively being conducted on computational devices that can perform computations on various types of data within a short period.

### SUMMARY

Some example embodiments provide a calculation circuit, a memory device including the calculation circuit, and/or a calculation method that can perform computations on various types of data within a short period.

However, aspects of example embodiments are not restricted to those set forth herein. The above and other aspects of some example embodiments will become more apparent to one of ordinary skill in the art to which inventive concepts pertain by referencing the detailed description given below.

According to some example embodiments, there is provided a calculation circuit comprising an input allocator configured to receive and divide n-bit input data (where n is a natural number equal to or greater than 2) into a plurality of operation elements based on a data type of the input data, an adder tree configured to perform a multiplication operation between the operation elements, and an accumulator configured to generate a first output value by adding an output value of the adder tree to a value stored in an accumulation register. The first output value includes a sign bit and data bits, and the accumulator includes a first lightweight normalizer configured to perform bit shifting on the first output value by comparing a value of the sign bit with values of m bits (where m is a natural number greater than, less than, or equal to n) among the data bits.

Alternatively or additionally according to some example embodiments, there is provided a memory device comprising a memory cell array configured to store data, and a processing-in-memory (PIM) device configured to be provided with data from the memory cell array and configured to perform an arithmetic operation, wherein the PIM device includes an input allocator configured to receive and divide n-bit input data (where n is a natural number equal to or greater than 2) into a plurality of operation elements based on a data type of the input data, an adder tree configured to perform a multiplication operation between the operation elements, and an accumulator configured to generate a first output value by adding an output value of the adder tree to a value stored in an accumulation register. The first output value includes a sign bit and data bits, and the accumulator includes a first lightweight normalizer configured to perform bit shifting on the first output value by comparing a value of the sign bit with values of m bits (where m is a natural number greater than n, less than n, or equal to n) among the data bits.

Alternatively or additionally according to some example embodiments, there is provided a calculation method comprising receiving and dividing n-bit input data (where n is a natural number equal to or greater than 2) into a plurality of operation elements based on a data type of the input data, performing a multiplication operation between the operation elements using an adder, generating a first output value including a sign bit and data bits, the generating the first output value performed by adding a value of a result of the multiplication operation to a value stored in an accumulation register, and performing bit shifting on the first output value by comparing a value of the sign bit with values of m bits (where m is a natural number greater than n, less than n, or equal to n) among the data bits.

It should be noted that the effects of some example embodiments are not limited to those described above, and other effects of some example embodiments will be apparent from the following description.

### BRIEF DESCRIPTION OF THE DRAWINGS

The above and other aspects and/or features of some example embodiments will become more apparent by describing in detail exemplary embodiments thereof with reference to the attached drawings, in which:

FIG. 1 is a diagram illustrating an example calculation circuit that performs a multiply accumulate (MAC) operation on floating point (FP)-type data;

FIG. 2 is a diagram illustrating example FP-type data;

FIG. 3 is a diagram illustrating a memory system according to some example embodiments;

FIG. 4 is a block diagram of a memory chip of FIG. 3;

FIG. 5 is a block diagram illustrating a PIM device of FIG. 3;

FIG. 6 is a block diagram illustrating an arithmetic logic unit (ALU) of FIG. 5;

FIG. 7 is a detailed block diagram of the ALU of FIG. 6;

FIG. 8 is a table illustrating example input data input to the ALU of FIG. 6;

FIGS. 9 through 11 are diagrams for explaining the operation of lightweight normalizers of FIG. 7;

FIG. 12 is a diagram illustrating example FP16-type data;

FIG. 13 is a diagram illustrating example BF16-type data;

FIG. 14 is a diagram for explaining an ALU that performs an FP16×FP16 or BF16×BF16 operation;

FIG. 15 is a diagram illustrating example FP8-type data;

FIG. 16 is a diagram illustrating example FP8-type data;

FIG. 17 is a diagram illustrating an ALU that performs an FP8×FP8 operation;

FIG. 18 is a diagram illustrating example MXINT8-type data and FP16-type data;

FIG. 19 is a diagram illustrating an ALU that performs an MXINT8×FP16 operation;

FIG. 20 is a diagram illustrating example INT8-type data;

FIG. 21 is a diagram illustrating an ALU that performs an INT8×INT8 operation;

FIG. 22 is a diagram illustrating example INT4-type data;

FIG. 23 is a diagram illustrating an ALU that performs an INT4×INT4 operation;

FIG. 24 is a flowchart illustrating a calculation method according to some example embodiments;

FIG. 25 is a diagram illustrating the effects of an ALU according to some example embodiments; and

FIG. 26 is a diagram illustrating a memory device according to some example embodiments.

### DETAILED DESCRIPTION

Some example embodiments will be described with reference to the attached drawings.

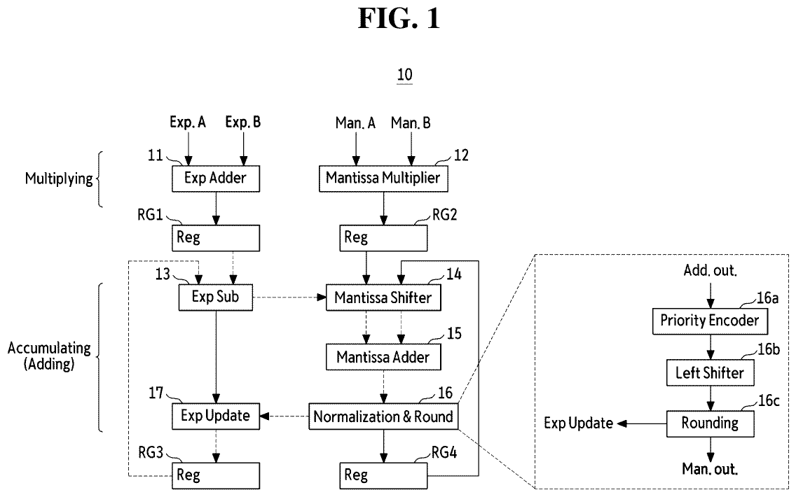

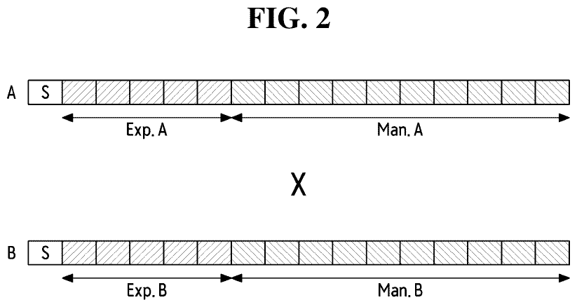

FIG. 1 is a diagram illustrating an example calculation circuit that performs a multiply accumulate (MAC) operation on floating point (FP)-type data. FIG. 2 is a diagram illustrating example FP-type data.

Referring to FIG. 1, a calculation circuit 10 may include an adder 11 and a multiplier 12, which are used to perform a multiplication operation on FP-type data A and FP-type data B, and a subtractor 13, a bit shifter 14, an adder 15, a normalizer 16, and an exponent updater 17, which are used to accumulate the result of the multiplication operation.

In some example embodiments, the data A and the data B may have the configuration illustrated in FIG. 2.

Referring to FIG. 2, the data A may include a sign bit S indicating whether the real number represented by data A is negative or positive, exponent bits Exp. A representing the exponent part of the data A, and data bits Man. A representing the fractional part of the data A. Since the data A is FP-type data, the data bits Man. A may be mantissa bits.

Similarly, the data B may include a sign bit S indicating whether the data B, which representing a real number, is negative or positive, exponent bits “Exp. B” representing the exponent part of the data B, and data bits “Man. B” representing the fractional part of the data B. Since the data B is FP-type data, the data bits “Man. B” may be mantissa bits.

The process of storing a binary number of, for example, 0.01101, in the form illustrated in FIG. 2 is as follows.

As an illustrative example, the binary number of 0.01101 may be expressed as 1.101×2⁻²; however, example embodiments are not necessarily limited thereto. In this case, the sign bit S may be stored as 0, indicating the binary number is positive, the exponent bits “Exp. A” may store bits corresponding to −2 according to a standard such as a variable standard (or, alternatively, a predefined standard), and the data bits “Man. A” may store bits corresponding to 101 according to the standard.

Therefore, when the data A and the data B are stored as illustrated in FIG. 2, the multiplication of the data A and the data B may be performed as illustrated in FIG. 1 by adding the exponent bits “Exp. A” of the data A and the exponent bits “Exp. B” of the data B using the adder 11, and multiplying the data bits “Man. A” of the data A and the data bits “Man. B” of the data B using the multiplier 12.

The result of the operation by the adder 11 may be stored in a register RG1, and the result of the operation by the multiplier 12 may be stored in a register RG2.

Thereafter, an accumulation operation, which adds the result of the multiplication of the data A and the data B to an existing accumulation result (e.g., the accumulation result up to a (k−1)-th iteration assuming that the current iteration is a k-th iteration), may be performed as follows using the calculation circuit 10 of FIG. 1.

In some example embodiments, the subtractor 13 calculates the difference between the accumulation result for exponent bits stored in a register RG3 up to the current iteration and the exponent bits resulting from the multiplication of the data A and the data B stored in the register RG1. This subtraction operation is for determining the difference to align the exponents of the two values to be added.

Thereafter, the bit shifter 14 shifts the bits of either the accumulation result for data bits stored in a register RG4 up to the current iteration or the data bits resulting from the multiplication of the data A and the B stored in the register RG2, using the result of the operation by the subtractor 13 (e.g., aligns the digits of the two values to be added). Then, the two values are added using the adder 15.

Thereafter, the normalizer 16 performs normalization on the data bits. Here, normalization is the process of converting the result of the operation by the adder 15 into the form of, for example, 1.XXXX (where different X may be ‘0’ or ‘1’ For example, if the result of the operation by the adder 15 is 0.001011, the normalizer 16 first searches for the position of the first “1” below the decimal point using an encoder 16a. Then, based on the position of the detected “1”, the normalizer 16 uses a bit shifter 16b to perform bit shifting to convert 0.001011 into 1.011 and, if necessary or desirable, uses a rounding circuit 16c to remove unnecessary zeros through rounding.

In this example, since a 3-bit shifting is performed through normalization, the normalizer 16 provides relevant information to the exponent updater 17 so that −3 is reflected in the exponent bits.

Then, the result for the accumulated exponent bits may be stored in the register RG3, and the result for the accumulated data bits may be stored in the register RG4.

Since normalization is performed whenever a new value is added during an accumulation step indicated by dashed lines in FIG. 1, it may be difficult to perform an accumulation operation within a short period using the calculation circuit 10. Alternatively or additionally, if the calculation circuit 10 is employed in a processing-in-memory (PIM) device of a memory system, it becomes challenging to perform the accumulation operation within a unit cycle, which is the basic operating unit of the memory device. Therefore, additional registers may be required or desired, in addition to those illustrated in FIG. 1 to support the accumulation operation.

Additionally or alternatively, in the case of the calculation circuit 10, since there is no logic to actively distribute input data based on the data type, inefficient computations may occur depending on the input data type.

A calculation circuit (e.g., a PIM device) that can overcome or at least partly overcome or improve upon these and other issues and perform computations on various types of data within a short period will hereinafter be described.

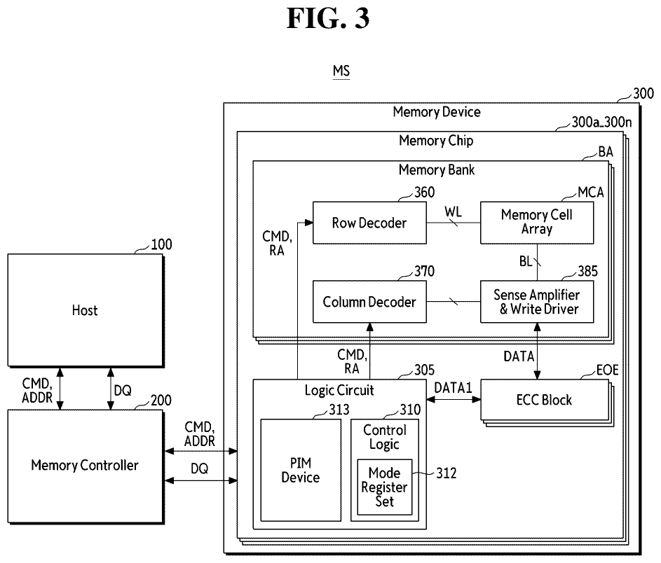

FIG. 3 is a diagram illustrating a memory system according to some example embodiments.

Referring to FIG. 3, a memory system MS may include a host 100, a memory controller 200, and a memory device 300.

The host 100 may transmit commands CMD and addresses ADDR to the memory device 300 via the memory controller 200. Alternatively or additionally, the host 100, which includes the memory controller 200, may transmit the commands CMD and the addresses ADDR to the memory device 300. The host 100 may exchange data signals DQ with the memory controller 200.

For example, the host 100 may transmit a write command CMD, an address ADDR, and a data signal DQ to the memory controller 200. In response, the memory controller 200 may transmit the write command CMD and address ADDR to the memory device 300.

The memory controller 200 may transmit the data signal DQ to the memory device 300 to write data to the memory device 300. The memory device 300 may write data to memory cells corresponding to the write command CMD and address ADDR received from the memory controller 200.

For example, the host 100 may transmit a read command CMD and an address ADDR to the memory controller 200. The memory controller 200 may transmit the read command CMD and address ADDR to the memory device 300. The memory device 300 may read data from memory cells corresponding to the read command CMD and address ADDR received from the memory controller 200 and transmit the read data as a data signal DQ to the memory controller 200. Then, the memory controller 200 may transmit the data signal DQ to the host 100.

For example, the memory controller 200 may store a PIM instruction set in the memory device 300 before transmitting the read command CMD and address ADDR to the memory device 300. The PIM instruction set may include at least one of various setting commands defined by a standard.

Through the PIM instruction set, the memory device 300 may read data from memory cells corresponding to a PIM address, which is generated independently of at least part of the address ADDR received from the memory controller 200. The memory device 300 may then perform a PIM operation based on the read data.

In some example embodiments, the memory device 300 may include a dynamic random-access memory (DRAM), but example embodiments are not limited thereto. Alternatively or additionally, in some example embodiments, the memory device 300 may be implemented as and/or may include one or more of various random access memories such as a static random-access memory (SRAM), a magnetic random-access memory (MRAM), a phase-change random-access memory (PRAM), a ferroelectric random-access memory (FRAM), and a resistive random-access memory (RRAM).

In some example embodiments, the memory device 300 may be or include (or may be included in) a high bandwidth memory (HBM), but example embodiments are not limited thereto.

The memory device 300 may include a plurality of memory chips 300a through 300n. For convenience, only the memory chip 300a will hereinafter be described, but the following description may also be applicable to the other memory chips; each of the plurality of memory chips 300a through 300n may store the same amount, and/or different amounts, of data; example embodiments are not limited thereto.

The memory chip 300a may include a plurality of memory banks BA, error correction code (ECC) blocks EOE, and a logic circuit 305.

Each of the memory banks BA may include a memory cell array MCA, a row decoder 360, a sense amplifier and write drive 385, and a column decoder 370.

The memory cell array MCA may include a plurality of memory cells that are arranged in row and column directions. Each of the memory cells may be connected to one of a plurality of wordlines WL(e.g., rows) and one of a plurality of bitlines BL (e.g., columns).

The row decoder 360 may operate in response to control from the logic circuit 305. Based on a command CMD and a row address RA received from the logic circuit 305, the row decoder 360 may activate a wordline WL selected from among the plurality of wordlines WL as an access target.

The sense amplifier and write driver 385 may operate in response to control from the logic circuit 305. The sense amplifier and write driver 385 may be connected to the memory cells via each of the plurality of bitlines BL.

The column decoder 370 may operate in response to control from the logic circuit 305. The column decoder 370 may be connected to the sense amplifier and write driver 385. Based on a command CMD and a column address CA received from the logic circuit 305, the column decoder 370 may select one or more bitlines BL from among the bitlines BL.

The memory chip 300a may include a plurality of ECC blocks EOE. The ECC blocks EOE may be connected to the respective memory banks BA.

The ECC blocks EOE may perform error correction encoding on data transmitted to the memory banks BA using ECC. The ECC blocks EOE may perform error correction decoding on data received from the memory banks BA using the ECC.

The logic circuit 305 may store a PIM instruction set received from the host 100 through the memory controller 200. The PIM instruction set may include at least one of various setting commands defined by a standard.

When the logic circuit 305 receives a command CMD and an address ADDR from the memory controller 200, the logic circuit 305 may determine the operation mode of the memory chip 300a based on whether there exists a PIM instruction set.

If there is no PIM instruction set in the logic circuit 305, the memory chip 300a may write data to the memory banks BA based on a write command CMD, an address ADDR, and a data signal DQ received from the memory controller 200, or read data stored in the memory banks BA based on a read command and address received from the memory controller 200.

If a PIM instruction set exists in the logic circuit 305, the memory chip 300a may perform a PIM operation. The logic circuit 305 may include a PIM device 313 and control logic 310. The PIM device 313 may execute a PIM command corresponding to the PIM instruction set based on the command CMD and address ADDR received from the memory controller 200.

The control logic 305 may receive a command CMD and an address ADDR from the memory controller 200. The control logic 305 may control the PIM device 313 to execute a PIM command corresponding to the PIM instruction set based on the received command CMD and address ADDR.

The control logic 305 may include a mode register set 312. The mode register set 312 may include information regarding a pre-set mode received from the memory controller 200.

For example, the mode register set 312 may include information regarding the operating mode of the memory chip 300a and/or the mode for reporting error generated in the memory chip 300a to the host 100. However, the information included in the mode register set 312 is not particularly limited and may be modified as appropriate.

When the PIM device 313 receives a read command CMD and address ADDR from the memory controller 200, the PIM device 313 may read data DATA from selected memory cells in a selected memory bank BA. In this case, the ECC blocks EOE may receive the data DATA from the selected memory cells.

The ECC blocks EOE may perform error correction decoding on the data DATA from the selected memory cells using ECC. If error correction for the data DATA has been successful, the PIM device 313 may receive error-corrected data DATA1 from the ECC blocks EOE.

The ECC blocks EOE may determine that error correction for the data DATA is impossible based on the results of the error correction decoding. In this case, ECC blocks EOE may generate an error correction failure code. The ECC blocks EOE may then transmit the error correction failure code to the logic circuit 305.

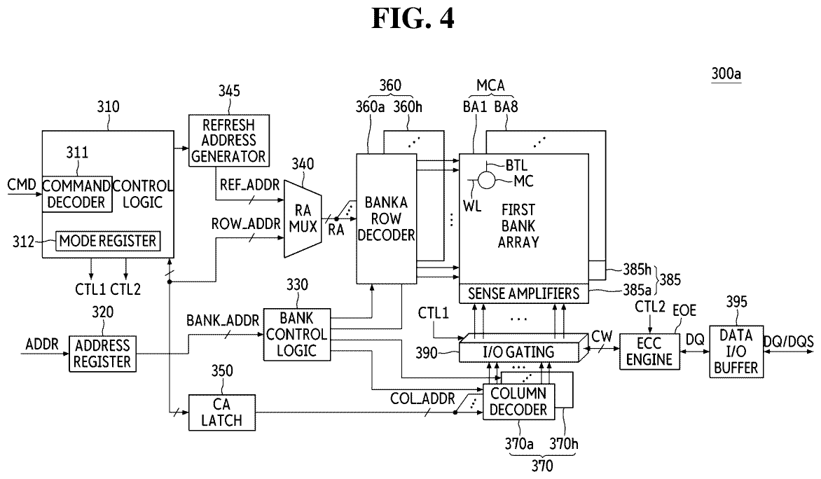

FIG. 4 is a block diagram of the memory chip 300a of FIG. 3.

Referring to FIG. 4, the memory chip 300a may include the control logic 310, an address register 320, bank control logic 330, a row address multiplexer 340, a refresh address generator 345, a column address latch 350, a row decoder 360, a column decoder 370, a sense amplifier unit 385, an input/output (I/O) gating circuit 390, a memory cell array MCA, an ECC engine EOE, and a data I/O buffer 395.

The memory cell array MCA may include a plurality of memory cells MC for storing data; the data may be or include one or more of text data, image data, computer-instruction data, etc. with example embodiments not limited thereto. For example, the memory cell array MCA may include first through eighth bank arrays BA1 through BA8. Each of the first through eighth bank arrays BA1 through BA8 may include a plurality of wordlines WL, a plurality of bitlines BTL, and a plurality of memory cells MC that are arranged at the intersections between the wordlines WL and the bitlines BTL.

The memory cell array MCA may include the first through eighth bank arrays BA1 through BA8. FIG. 4 illustrates the memory chip 300a as including eight bank arrays, e.g., the first through eighth bank arrays BA1 through BA8, but example embodiments are not limited thereto. That is, the memory chip 300a may include any number of bank arrays.

The control logic 310 may control the operation of the memory chip 300a. For example, the control logic 310 may generate control signals CTL1 and CTL2 to control the memory chip 300a to perform a write operation or a read operation. The control logic 310 may include a command decoder 311 for decoding a command CMD received from the host 100 and a mode register 312 for setting the operating mode of the memory chip 300a.

For example, the command decoder 311 may generate control signals corresponding to the command CMD by decoding one or more of a write enable signal, a row address strobe signal, a column address strobe signal, a chip select signal, etc. The control logic 310 may also or alternatively receive a clock signal and a clock enable signal to drive the memory chip 300a in a synchronous manner.

Additionally or alternatively, the control logic 310 may control the refresh address generator 345 to generate a refresh row address REF_ADDR in response to a refresh command.

The address register 320 may receive an address ADDR from the host 100. For example, the address register 320 may receive an address ADDR that includes a bank address BANK_ADDR, a row address ROW_ADDR, and a column address COL_ADDR. The address register 320 may provide the bank address BANK_ADDR to the bank control logic 330, the row address ROW_ADDR to the row address multiplexer 340, and the column address COL_ADDR to the column address latch 350.

The bank control logic 330 may generate bank control signals in response to the bank address BANK_ADDR received from the address register 320. In response to these bank control signals, the bank row decoder corresponding to the bank address BANK_ADDR among first through eighth bank row decoders 360a through 360h may be activated, and the bank column decoder corresponding to the bank address BANK_ADDR among first through eighth bank column decoders 370a through 370h may also be activated.

The row address multiplexer 340 may receive the row address ROW_ADDR from the address register 320 and the refresh row address REF_ADDR from the refresh address generator 345. The row address multiplexer 340 may selectively output the row address ROW_ADDR received from the address register 320 or the refresh row address REF_ADDR received from the refresh address generator 345 as a row address RA. The row address RA output from the row address multiplexer 340 may be applied to each of the first through eighth bank row decoders 360a through 360h.

The refresh address generator 345 may generate the refresh row address REF_ADDR to refresh the memory cells MC. The refresh address generator 345 may provide the refresh row address REF_ADDR to the row address multiplexer 340. Accordingly, the memory cells MC aligned with the wordline WL corresponding to the refresh row address REF_ADDR may be refreshed.

The column address latch 350 may receive the column address COL_ADDR from the address register 320 and temporarily store the received column address COL_ADDR. Additionally or alternatively, in burst mode, the column address latch 350 may gradually increase the received column address COL_ADDR. The column address latch 350 may apply the temporarily stored or gradually increased column address COL_ADDR to each of the first through eighth bank column decoders 370a through 370h.

The row decoder 360 may include the first through eighth bank row decoders 360a through 360h, which are connected to the first through eighth bank arrays BA1 through BA8, respectively. The column decoder 370 may include the first through eighth bank column decoders 370a through 370h, which are connected to the first through eighth bank arrays BA1 through BA8, respectively. The sense amplifier unit 385 may include first through eighth bank sense amplifiers 385a through 385h, which are connected to the first through eighth bank arrays BA1 through BA8, respectively.

The bank row decoder activated by the bank control logic 330 among the first through eighth bank row decoders 360a through 360h may decode the row address RA output from the row address multiplexer 340 and activate the wordline corresponding to the row address RA. For example, the activated bank row decoder may apply a wordline drive voltage to the wordline WL corresponding to the row address RA.

The bank column decoder activated by the bank control logic 330 among the first through eighth bank column decoders 370a through 370h may activate the bank sense amplifier corresponding to the bank address BANK_ADDR and the column address COL_ADDR through the input/output gating circuit 390.

The I/O gating circuit 390 may include circuits for gating input/output data, input data mask logic, read data latches for storing data output from the first through eighth bank arrays BA1 through BA8, and write drivers for writing data to the first through eighth bank arrays BA1 through BA8.

A codeword CW to be read from one of the first through eighth bank arrays BA1 through BA8 may be detected by the corresponding bank sense amplifier 385a to 385h and stored in the read data latches.

The ECC engine EOE may perform ECC decoding on the codeword CW stored in the read data latches. If an error is detected in the data of the codeword CW, the ECC engine EOE may provide a corrected data signal DQ to an external memory controller through the data I/O buffer 395.

A data signal DQ to be written to one of the first through eighth bank arrays BA1 through BA8 may be provided to the ECC engine EOE, and the ECC engine EOE may generate parity bits based on the data signal DQ and provide the data signal DQ and the parity bits to the I/O gating circuit 390. The I/O gating circuit 390 may write the data signal DQ and the parity bits to a sub-page of one of the first through eighth bank arrays BA1 through BA8 through the write drivers.

The data I/O buffer 395 may receive a data signal DQ and a data strobe signal DQS from an external source. In some example embodiments, the data input/output buffer 395 may include a first data I/O buffer (e.g., a data buffer) that receives the data signal DQ from the external source and a second data input/output buffer (e.g., a data strobe buffer) that receives the data strobe signal DQS from the external source.

During a write operation, the data I/O buffer 395 may buffer or drive the data signal DQ (e.g., write data) and provide it to the ECC engine EOE. During a read operation, the data I/O buffer 395 may buffer or drive the data signal DQ (e.g., read data) provided by the ECC engine EOE and deliver it to the outside.

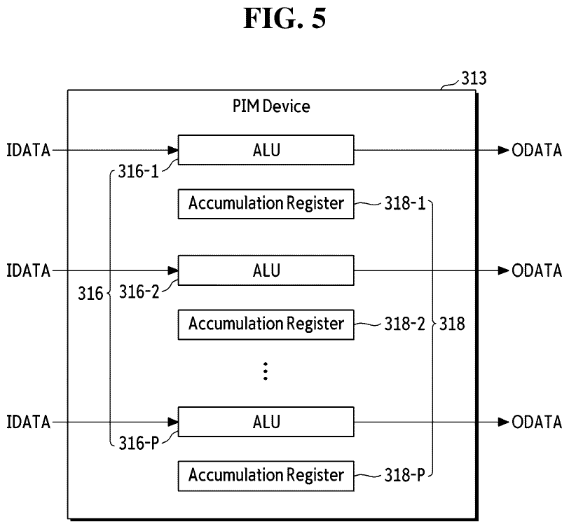

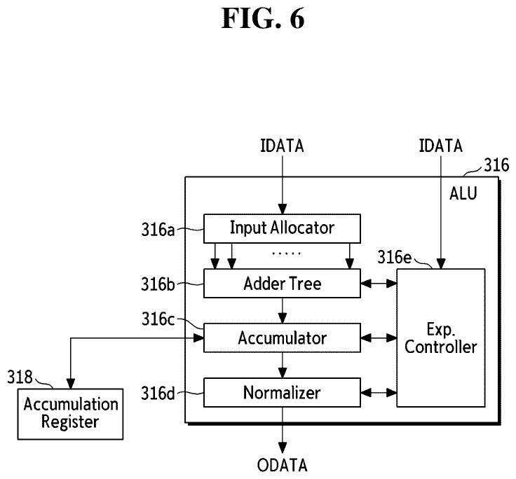

FIG. 5 is a block diagram illustrating the PIM device of FIG. 3. FIG. 6 is a block diagram illustrating an arithmetic logic unit (ALU) of FIG. 5.

Referring to FIG. 5, the PIM device 313 may include a plurality of ALUs 316, e.g., first through P-th ALUs 316-1 through 316-P (where P is an integer greater than or equal to 2) of a Single Instruction Multiple Data (SIMD) structure, and a plurality of accumulation registers 318, e.g., first through P-th accumulation registers 318 corresponding to the first through P-th ALUs 316-1 through 316-P, respectively.

The ALUs 316 may perform an MAC operation using input data IDATA. For example, the ALUs 316 may perform a multiplication operation on the input data IDATA, add the result of the multiplication operation to previous computation data stored in the respective accumulators registers 318, and store the result of the addition in the respective accumulation registers 318. If necessary or desirable, the ALUs 316 may output accumulated computation result data as output data ODATA.

In some example embodiments, the input data IDATA received by the ALUs 316 may be data DATA1 provided from the memory banks BA of FIG. 3, but example embodiments are not limited thereto.

The accumulation registers 318 may provide the previous computation data required by the ALUs 316 for performing a MAC operation and store new computation data received from the ALUs 316.

Referring to FIG. 6, an ALU 316 may include an input allocator 316a, an adder tree 316b, an accumulator 316c, a normalizer 316d, and an exponent controller 316e.

The input allocator 316a may receive the input data IDATA and divide n-bit (where n is an integer greater than or equal to 2) data into a plurality of operation elements based on the data type of the input data IDATA, and provide the operation elements to the adder tree 316b.

The adder tree 316b may perform multiplication operations between the operation elements received from the input allocator 316a using a plurality of adders.

The accumulator 316c may perform an accumulation operation by adding the output value of the adder tree 316b to the value stored in the accumulation register 318.

The normalizer 316d may normalize the result of the accumulation operation by the accumulator 316c and output the result of the normalization as output data ODATA if external output is required.

The exponent controller 316e may receive the input data IDATA and manage the value stored in the exponent bits during a MAC operation.

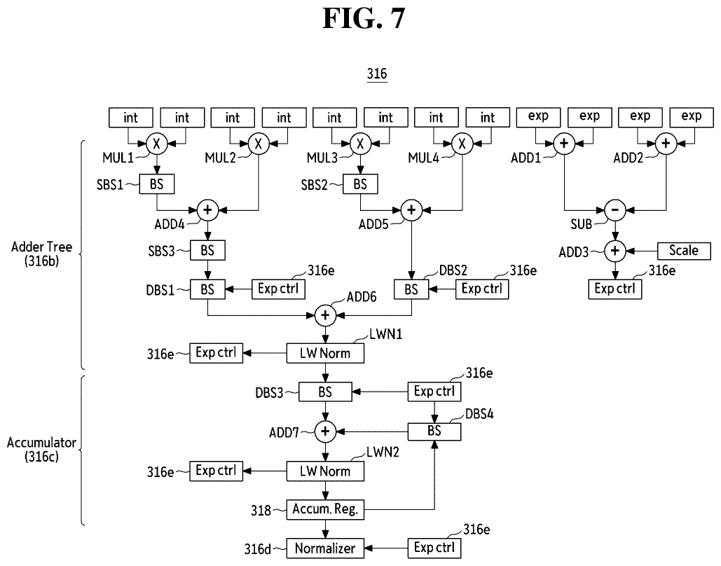

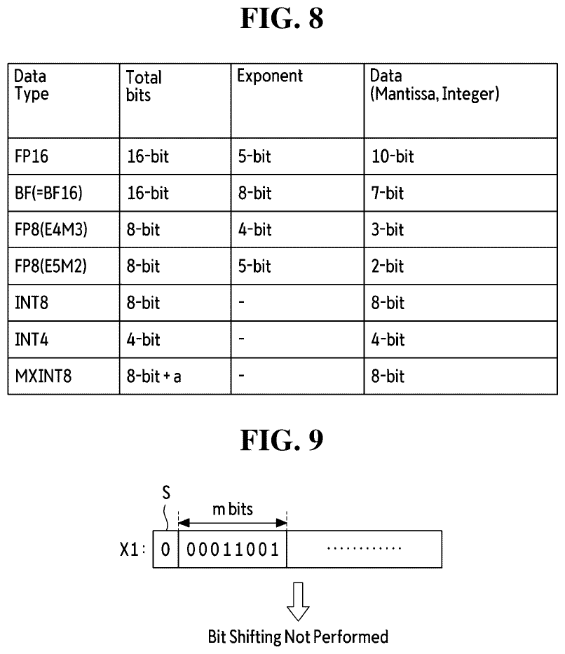

FIG. 7 is a detailed block diagram of the ALU of FIG. 6. FIG. 8 is a table illustrating example input data input to the ALU of FIG. 6. FIGS. 9 through 11 are diagrams for explaining the operation of lightweight normalizers of FIG. 7.

Referring to FIG. 7, the adder tree 316b may include a plurality of multipliers MUL1, MUL2, MUL3, and MUL4, a plurality of adders ADD1, ADD2, ADD3, ADD4, ADD5, and ADD6, a subtractor SUB, a plurality of static bit shifters SBS1, SBS2, and SBS3, a plurality of dynamic bit shifters DBS1 and DBS2, and a lightweight normalizer (“LWNorm”) LWN1.

The accumulator 316c may include a plurality of dynamic bit shifters DBS3 and DBS4, an adder ADD7, and a lightweight normalizer LWN2.

The ALU 316 can perform MAC operations on input data of various data types, as shown in FIG. 8.

The input allocator 316a of FIG. 6 may divide or partition n-bit input data (where n is a natural number greater than or equal to 2) into a plurality of operation elements, based on the data type of the input data, The input allocator 316a of FIG. 6 may provide the operation elements as input to the multipliers MUL1, MUL2, MUL3, and MUL4 and the adders ADD1 and ADD2 in the adder tree 316b.

Through repeated testing, researchers of inventive concepts have verified that when n is 32, the computation efficiency of the ALU 316 is improved or maximized in consideration of the input data. Thus, some example embodiments will hereinafter be explained using the example where n is 32, although example embodiments are not necessarily limited thereto.

The input allocator 316a of FIG. 6 may divide the data bits and exponent bits of the input data into a plurality of operation elements and may provide the operation elements to the adder tree 316b.

For example, referring to FIG. 7, the input allocator 316a may provide data bits “int” to the multipliers MUL1, MUL2, MUL3, and MUL4 and may provide exponent bits “exp” to the adders ADD1 and ADD2.

The multipliers MUL1, MUL2, MUL3, and MUL4 may perform multiplication operations on the input operation elements “int”and output the results.

The adders ADD1 and ADD2 may perform addition operations on the input operation elements “exp” in FIG. 7 and output the results.

The static bit shifter SBS1 may perform bit shifting on the output of the multiplier MUL1 by a first number of bits. Here, the first number of bits may be determined based on the data type of the input data provided to the ALU 316.

For example, the number of bits shifted by the static bit shifter SBS1 during an FP16×FP16 operation performed by the ALU 316 may differ from the number of bits shifted during a BF16×BF16 (or brain floating point) operation performed by the ALU 316.

The static bit shifter SBS2 may perform bit shifting on the output of the multiplier MUL3 by a second number of bits. Here, the second number of bits may be determined based on the data type of the input data provided to the ALU 316.

The adder ADD4 may add the output of the static bit shifter SBS1 and the output of the multiplier MUL2. The adder ADD5 may add the output of the static bit shifter SBS2 and the output of the multiplier MUL4.

The subtractor SUB may calculate the difference between the output of the adder ADD1 and the output of the adder ADD2.

If the data type of the input data is MXINT8, the adder ADD3 may add the scale bits of the input data and the output of the subtractor SUB. The output of the adder ADD3 may be provided to the exponent controller 316e and reflected in the exponent bits of computation data.

The dynamic bit shifter DBS1 may receive exponent bit information of the computation data from the exponent controller 316e and may perform bit shifting on the output of the adder ADD4 or the output of the static bit shifter SBS1 based on the received exponent bit information. The dynamic bit shifter DBS2 may receive exponent bit information of the computation data from the exponent controller 316e and perform bit shifting on the output of the adder ADD5 based on the received exponent bit information.

The adder ADD6 may perform an addition operation on the output of the adder ADD4, the output of the static bit shifter SBS1, or the output of the dynamic bit shifter DBS1 with the output of the adder ADD5 or the output of the dynamic bit shifter DBS2.

In some example embodiments, at least some of the components within the adder tree 316b, e.g., at least some of the multipliers MUL1, MUL2, MUL3, and MUL4, adders ADD1, ADD2, ADD3, ADD4, ADD5, and ADD6, subtractor SUB, static bit shifters SBS1, SBS2, and SBS3, and dynamic bit shifters DBS1 and DBS2, may be disabled and not perform computations depending on the data type of the input data. This will be explained later in detail.

The lightweight normalizer LWN1 may perform lightweight normalization on the output of the adder ADD6.

Here, lightweight normalization involves comparing the value of the sign bit of the output of the adder ADD6 and the values of m bits (where m is a natural number that may be greater than, equal to or less than n) among the data bits of the output of the adder ADD6, and performing bit shifting. In some example embodiments, lightweight normalization involves performing bit shifting if all the m bits have the same value as the sign bit.

Lightweight normalization will hereinafter be described in further detail. Referring first to FIG. 9, data X1 has a sign bit S that is zero and m bits within the data bits that are not all zeros. In this case, the lightweight normalizer LWN1 does not perform bit shifting. Consequently, the exponent bits of the computation data may not change.

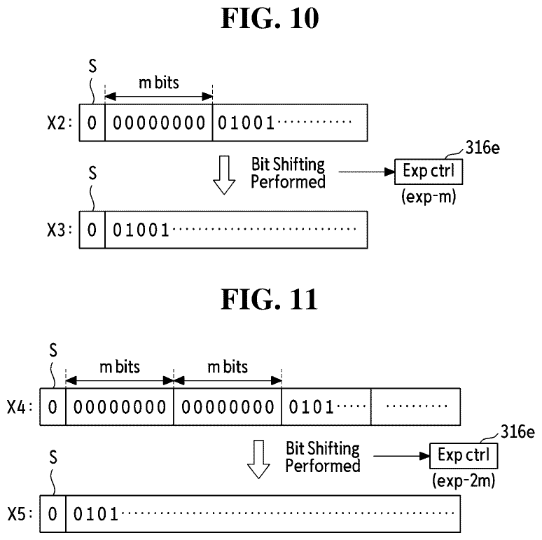

Referring to FIG. 10, data X2 has a sign bit S that is zero and m bits within the data bits that are all zeros. In this case, the lightweight normalizer LWN1 performs m-bit shifting on the data X2 and outputs data X3. As a result, the exponent bits of the computation data change by −m.

Referring to FIG. 11, data X4 has a sign bit S that is zero and first and second sets of m bits within the data bits that are all zeros. In this case, the lightweight normalizer LWN1 performs two rounds of m-bit shifting on the data X4 and outputs data X5. As a result, the exponent bits of the computation data change by −2m.

By performing a lightweight normalization operation that only checks the values of m bits within the data bits, instead of the normalization operation described above with reference to FIG. 1, the ALU 316 can perform a MAC operation more quickly.

The result of the lightweight normalization operation may lead to an increase in the number of bits in the data bits compared to the result of the normalization operation of FIG. 1, requiring a slightly larger accumulation register 318. However, this lightweight normalization operation can be performed much faster than the normalization operation of FIG. 1. Additionally or alternatively, simulation results show that the error in the computation result from the lightweight normalization operation is almost similar to the error in the computation result from the normalization operation of FIG. 1. Therefore, computation with a similar accuracy can be achieved within a relatively short period of time using the lightweight normalization operation compared to the computation using the normalization operation of FIG. 1. This will be described later in further detail.

Meanwhile, through repeated testing, the researchers have verified that when m is 8, the data error rate is minimized, and computation efficiency is improved or maximized. Therefore, some example embodiments will hereinafter be explained using the example where m is 8.

The adder ADD7 included in the accumulator 316c may add the previous computation result stored in the accumulation register 318 and the result from the adder tree 316b.

To this end, the accumulator 316c may include a dynamic bit shifter DBS3 that performs bit shifting on the output of the adder tree 316b and a dynamic bit shifter DBS4 that performs bit shifting on the value stored in the accumulation register 318.

The dynamic bit shifters DBS3 and DBS4 are for aligning the digits between the output of the adder tree 316b and the value stored in the accumulation register 318 so that the adder ADD7 may perform an addition operation.

The lightweight normalizer LWN2 may perform lightweight normalization on the output of the adder ADD7. The operation of the lightweight normalizer LWN2 is similar to the operation of the lightweight normalizer LWN1 described earlier, and thus, a redundant explanation thereof will be omitted.

The normalizer 316d may perform the normalization operation of FIG. 1 on the output of the accumulator 316c or the output of the accumulation register 318. For example, the ALU 316 can increase computation efficiency by performing the normalization operation of FIG. 1 when external output of computation result data is required (e.g., when there is a need to transmit the computation result data to the host 100 or store the computation result data in a memory cell array) and performing a lightweight normalization operation during a MAC operation.

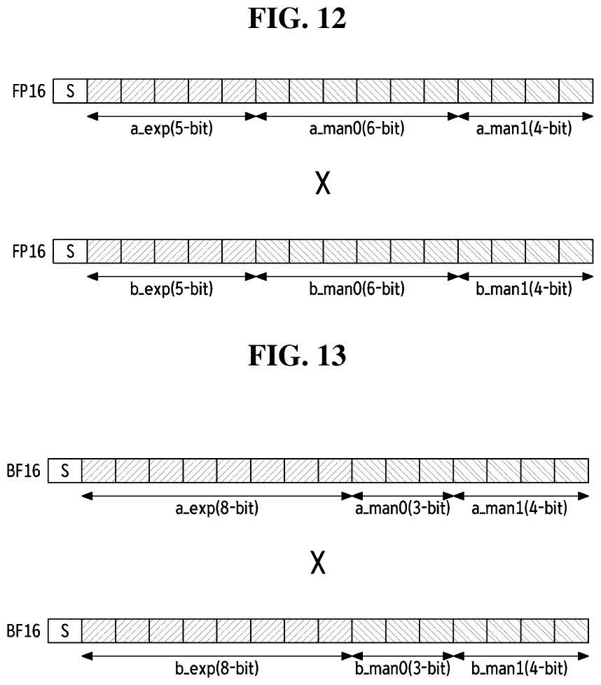

MAC operations by the ALU 316 for various data types will hereinafter be described with reference to FIGS. 12 through 23.

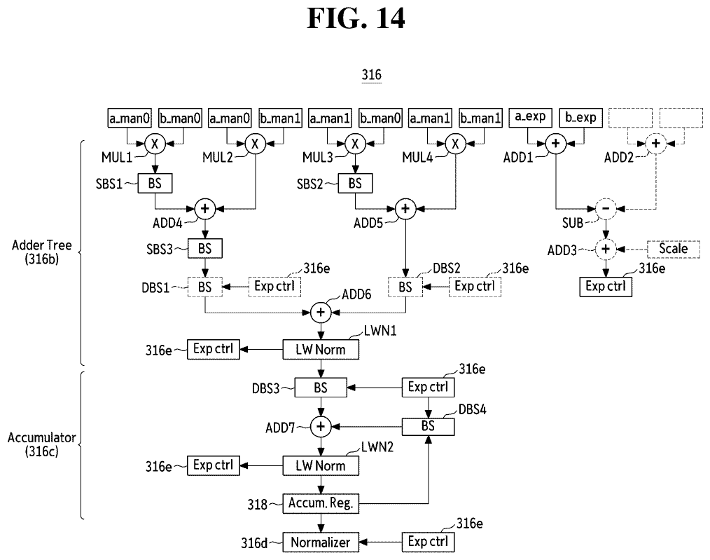

FIG. 12 is a diagram illustrating example FP16-type data. FIG. 13 is a diagram illustrating example BF16-type data. FIG. 14 is a diagram for explaining an ALU 316 that performs an FP16×FP16 or BF16×BF16 operation.

Referring first to FIG. 12, FP16-type data may include one sign bit S, five exponent bits a_exp, and ten data bits (a_man0 and a_man1).

The input allocator 316a of FIG. 6 may divide the 32-bit data into a plurality of operation elements, e.g., a_exp, a_man0, a_man1, b_exp, b_man0, and b_man1.

The input allocator 316a of FIG. 6 may then provide the divided operation elements to the adder tree 316b of FIG. 14.

Here, the operation elements corresponding to data bits, e.g., a_man0 and b_man0, may be provided to the multiplier MUL1, the operation elements corresponding to data bits, e.g., a_man0 and b_man1, may be provided to the multiplier MUL2, the operation elements corresponding to data bits, e.g., a_man1 and b_man0, may be provided to the multiplier MUL3, and the operation elements corresponding to data bits, e.g., a_man1 and b_man1, may be provided to the multiplier MUL4. Additionally, the operation elements corresponding to exponent bits, e.g., a_exp and b_exp, may be provided to the adder ADD1.

Referring to FIG. 14, when the ALU 316 performs an FP16×FP16 operation, the dynamic bit shifters DBS1 and DBS2 may be disabled, and the adder ADD2, the subtractor SUB, and the adder ADD3 may also be disabled. In FIG. 14, the enabled components are indicated with solid lines, while the disabled components are indicated with dotted lines.

The adder tree 316b may perform the FP16×FP16 operation illustrated in FIG. 12 using the enabled components in FIG. 14 and may then perform a first lightweight normalization.

The multiplier MUL1 performs a multiplication operation on upper data bits a_man0 and upper data bit b_man0 and outputs the result of the multiplication operation. The multiplier MUL2 performs a multiplication operation on the upper data bits a_man0 and lower data bits b_man1 and outputs the result of the multiplication operation.

To add the results from the multipliers MUL1 and MUL2 using the adder ADD4, bit shifting for digit alignment is required on the result from the multiplier MUL1. Therefore, the static bit shifter SBS1 performs bit shifting, considering the divided operation elements of FIG. 12.

The multiplier MUL3 performs a multiplication operation on lower data bits a_man1 and the upper data bits b_man0 and outputs the result of the multiplication operation. The multiplier MUL4 performs a multiplication operation on the lower data bits a_man1 and the lower data bits b_man1 and outputs the result of the multiplication operation.

Similarly, to add the results from the multipliers MUL3 and MUL4 using the adder ADD5, bit shifting for digit alignment is required for the result from the multiplier MUL3. Therefore, the static bit shifter SBS2 performs bit shifting, considering the divided operation elements of FIG. 12.

Likewise, to add the results from the adders ADD4 and ADD5 using the adder ADD6, bit shifting for digit alignment is required for the result from the adder ADD4. Therefore, the static bit shifter SBS3 performs bit shifting, considering the divided operation elements of FIG. 12.

The output of the adder ADD6 is the result of the multiplication operation on the data bits as performed in the FP16×FP16 operation of FIG. 12.

The lightweight normalizer LWN1 performs the first lightweight normalization on the output of the adder ADD6 and outputs the result of the first lightweight normalization to the accumulator 316c.

Meanwhile, the adder ADD1 performs an addition operation on the exponent bits a_exp and the exponent bits b_exp and outputs the result of the addition operation. The output of the adder ADD1 may be reflected as the exponent bits of the result from the FP16×FP16 operation through the exponent controller 316e.

The accumulator 316c may add the result from the adder tree 316b to the value stored in the accumulation register 318 using the enabled components in FIG. 14, may perform a second lightweight normalization, and store the result of the second lightweight normalization in the accumulation register 318.

The previous computation accumulation value stored in the accumulation register 318 and the result value output from the adder tree 316b may have different digit counts (or exponential values). Therefore, to perform an addition operation using the adder ADD7, digit alignment is needed first.

One of the dynamic bit shifters DBS3 and DBS4 may perform bit shifting under the control of the exponent controller 316e. For example, if digit alignment is required for the result value output from the adder tree 316b to perform an addition operation using the adder ADD7, the dynamic bit shifter DBS3 may perform bit shifting on the result value output from the adder tree 316b. Additionally, if digit alignment is required for the previous computation accumulation value stored in the accumulation register 318 to perform an addition operation using the adder ADD7, the dynamic bit shifter DBS4 may perform bit shifting on the previous computation accumulation value stored in the accumulation register 318.

The lightweight normalizer LWN2 performs the second lightweight normalization on the output of the adder ADD7 and stores the result of the second lightweight normalization as a new accumulation value in the accumulation register 318.

Referring to FIG. 13, BF16-type data may include one sign bit S, eight exponent bits a_exp, and seven data bits (a_man0 and a_man1).

The input allocator 316a of FIG. 6 may divide the 32-bit data into a plurality of operation elements, e.g., a_exp, a_man0, a_man1, b_exp, b_man0, and b_man1, as illustrated in FIG. 13.

The input allocator 316a of FIG. 6 may provide the divided operation elements to the adder tree 316b, as illustrated in FIG. 14, and the ALU 316 may perform a BF16×BF16 operation using the aforementioned method (with the only difference being how the 32-bit data is divided into operation elements) and add the result of the BF16×BF16 operation to the existing computation result data.

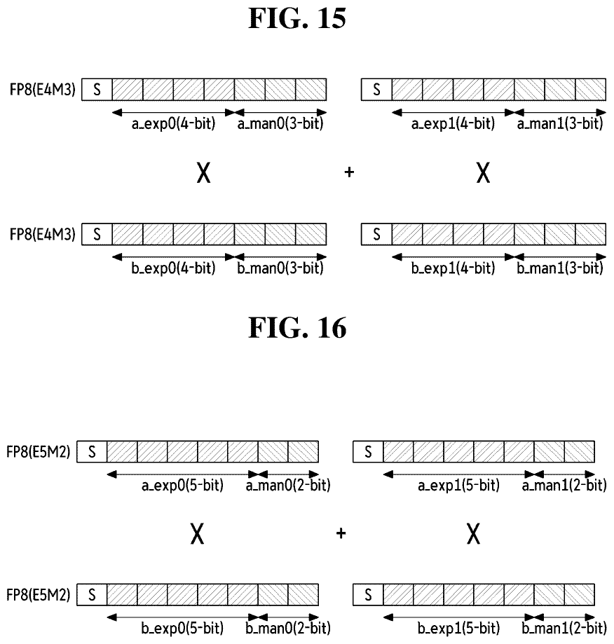

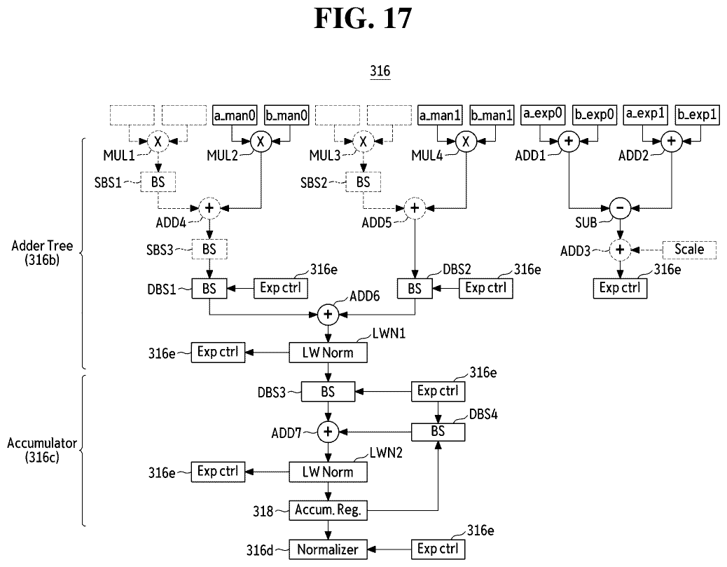

FIG. 15 is a diagram illustrating example FP8-type data. FIG. 16 is a diagram illustrating example FP8-type data. FIG. 17 is a diagram explaining an ALU 316 that performs an FP8×FP8 operation.

Referring first to FIG. 15, FP8-type type data (“FP8(E4M3)”) may include one sign bit S, four exponent bits a_exp0, and three data bits a_man0.

The input allocator 316a of FIG. 6 may divide the 32-bit data into a plurality of operation elements, e.g., a_exp0, a_man0, b_exp0, b_man0, a_exp1, a_man1, b_exp1, and b_man1, as illustrated in FIG. 15.

The input allocator 316a of FIG. 6 may then provide the divided operation elements to the adder tree 316b, as illustrated in FIG. 17.

Here, the operation elements corresponding to data bits, e.g., a_man0 and b_man0, may be provided to the multiplier MUL2, and the operation elements corresponding to data bits, e.g., a_man1 and b_man1, may be provided to the multiplier MUL4. Additionally, the operation elements corresponding to exponent bits, e.g., a_exp0 and b_exp0, may be provided to the adder ADD1, and the operation elements corresponding to exponent bits, e.g., a_exp1 and b_exp1, may be provided to the adder ADD2.

As illustrated in FIG. 17, when the ALU 316 performs an FP8×FP8 operation, the static bit shifters SBS1, SBS2, and SBS3, the multipliers MUL1 and MUL3, and the adders ADD3, ADD4, and ADD5 may be disabled. In FIG. 17, the enabled components are indicated with solid lines, while the disabled components are indicated with dotted lines.

The adder tree 316b may perform an FP8 (E4M3)×FP8 (E4M3) operation, as illustrated in FIG. 15, using the enabled components in FIG. 17 and may then perform a first lightweight normalization.

In some example embodiments illustrated in FIG. 15, unlike in the previous example embodiments, data bits are not divided into upper bits and lower bits. Thus, the static bit shifters SBS1, SBS2, and SBS3 are not used. Instead, digit alignment for multiplication result data is performed by the dynamic bit shifters DBS1 and DBS2 before an addition operation performed by the adder ADD6.

The dynamic bit shifters DBS1 and DBS2 may perform bit shifting under the control of the exponent controller 316e based on the result of an exponent bit operation using the adders ADD1 and ADD2 and the subtractor SUB.

The other features are similar to their counterparts of the previous embodiments, and thus, redundant explanations thereof will be omitted.

The accumulator 316c may add the result from the adder tree 316b to the value stored in the accumulation register 318 using the enabled components in FIG. 17, perform a second lightweight normalization, and store the result of the second lightweight normalization in the accumulation register 318.

Referring to FIG. 16, FP8-type data (“FP8 (E5M2)”) may include one sign bit S, five exponent bits a_exp0, and two data bits a_man0.

The input allocator 316a of FIG. 6 may divide the 32-bit data into a plurality of operation elements, e.g., a_exp0, a_man0, b_exp0, b_man0, a_exp1, a_man1, b_exp1, and b_man1, as illustrated in FIG. 16.

The input allocator 316a of FIG. 6 may then provide the divided operation elements to the adder tree 316b, as illustrated in FIG. 17, and the ALU 316 may perform an FP8 (E5M2)×FP8 (E5M2) operation using the aforementioned method and add the result of the FP8 (E5M2)×FP8 (E5M2) operation to the existing computation result data.

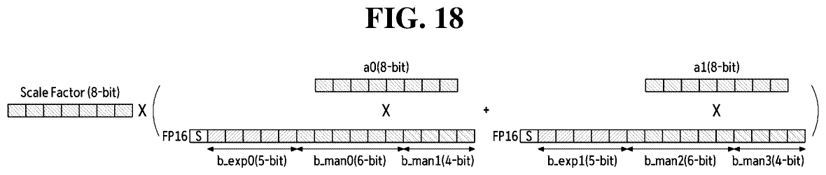

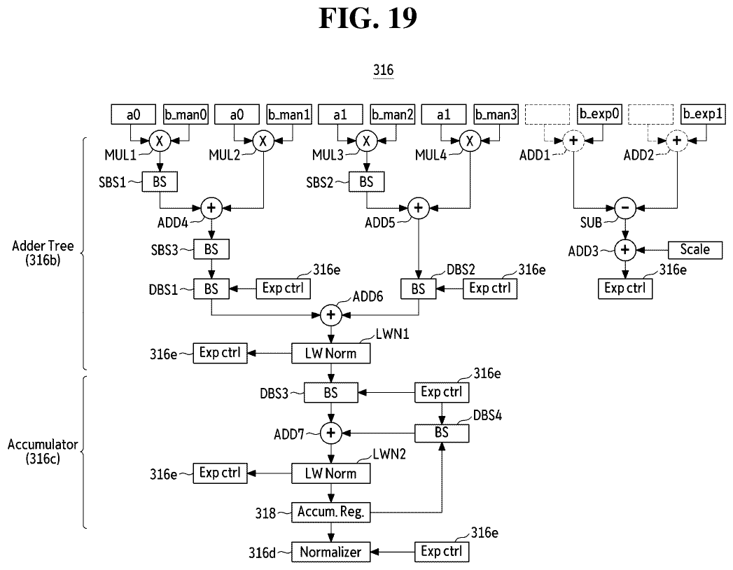

FIG. 18 is a diagram illustrating example MXINT8-type data and FP16-type data. FIG. 19 is a diagram illustrating an ALU 316 that performs an MXINT8×FP16 operation.

Referring to FIG. 18, the MXINT8-type data may include an 8-bit scale factor and eight data bits a0. The FP16-type data may include one sign bit S, five exponent bits b_exp0, and ten data bits (b_man0 and b_man1).

The input allocator 316a of FIG. 6 may divide the 32-bit data into a plurality of operation elements, e.g., the scale factor, a0, b_exp0, b_man0, b_man1, a1, b_exp1, b_man2, and b_man3, as illustrated in FIG. 18.

The input allocator 316a of FIG. 6 may then provide the divided operation elements to the adder tree 316b, as illustrated in FIG. 19.

Here, the operation elements corresponding to data bits, e.g., a0 and b_man0, may be provided to the multiplier MUL1, the operation elements corresponding to data bits, e.g., a0 and b_man1, may be provided to the multiplier MUL2, the operation elements corresponding to data bits, e.g., a1 and b_man2, may be provided to the multiplier MUL3, and the operation elements corresponding to data bits, e.g., a1 and b_man3, may be provided to the multiplier MUL4. Additionally, the operation elements corresponding to exponent bits, e.g., b_exp0 and b_exp1, may be provided to the subtractor SUB, and the operation element corresponding to the scale factor may be provided to the adder ADD3.

As illustrated in FIG. 19, when the ALU 316 performs an MXINT8×FP16 operation, the adders ADD1 and ADD2 may be disabled. In FIG. 19, the enabled components are indicated with solid lines, while the disabled components are indicated with dotted lines.

The adder tree 316b may perform an MXINT8×FP16 operation, as illustrated in FIG. 18, using the enabled components in FIG. 19 and may then perform a first lightweight normalization.

The accumulator 316c may add the result from the adder tree 316b to the value stored in the accumulation register 318 using the enabled components in FIG. 19, perform a second lightweight normalization, and store the result of the second lightweight normalization in the accumulation register 318.

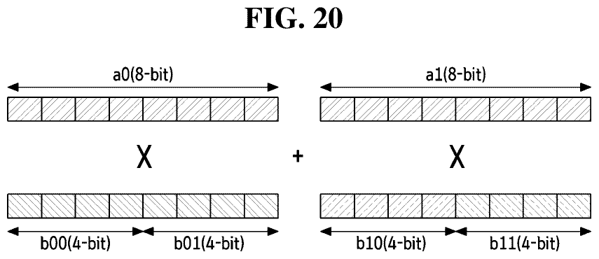

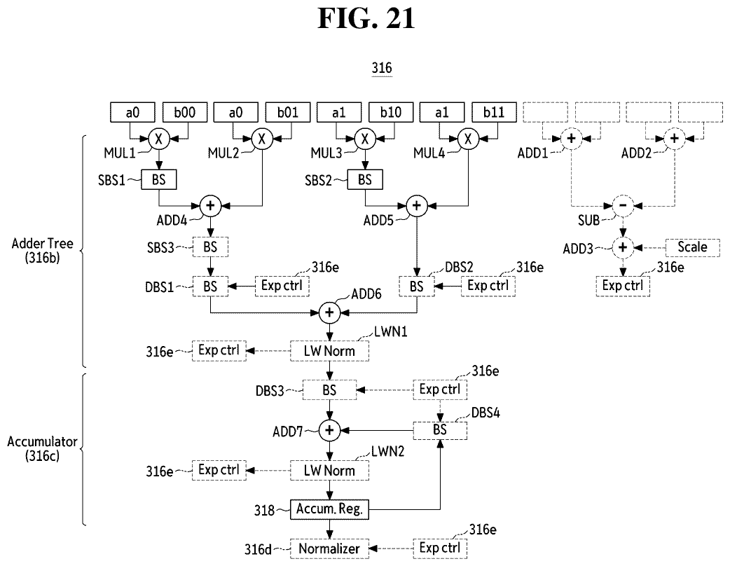

FIG. 20 is a diagram illustrating example INT8-type data. FIG. 21 is a diagram illustrating an ALU 316 that performs an INT8×INT8 operation.

Referring to FIG. 20, INT8-type data may include eight data bits a0.

The input allocator 316a of FIG. 6 may divide the 32-bit data into a plurality of operation elements, e.g., a0, b00, b01, a1, b10, and b11, as illustrated in FIG. 20. That is, the input allocator 316a may not divide the data bits of first INT8-type data into operation elements, and may divide the data bits of the second INT8-type data into two 4-bit operation elements.

The input allocator 316a of FIG. 6 may then provide the divided operation elements to the adder tree 316b, as illustrated in FIG. 21.

Here, the operation elements corresponding to data bits, e.g., a0 and b00, may be provided to the multiplier MUL1, the operation elements corresponding to data bits, e.g., a0 and b01, may be provided to the multiplier MUL2, the operation elements corresponding to data bits, e.g., a1 and b10, may be provided to the multiplier MUL3, and the operation elements corresponding to data bits, e.g., a1 and b11, may be provided to the multiplier MUL4.

Since INT-type data do not have exponent bits, the adders ADD1, ADD2, ADD3, and the subtractor SUB, which are related to an exponent bit operation, may be disabled. Additionally, the static bit shifter SBS3, the dynamic bit shifters DBS1, DBS2, DBS3, and DBS4, the lightweight normalizers LWN1 and LWN2, and the normalizer 316d may also be disabled, as normalization is not required for an INT operation. In FIG. 21, the enabled components are indicated with solid lines, while the disabled components are indicated with dotted lines.

The adder tree 316b may perform an INT8×INT8 operation, as illustrated in FIG. 20, using the enabled components in FIG. 21.

The accumulator 316c may add the result from the adder tree 316b to the value stored in the accumulation register 318 using the enabled components in FIG. 21 and store the result of the addition in the accumulation register 318.

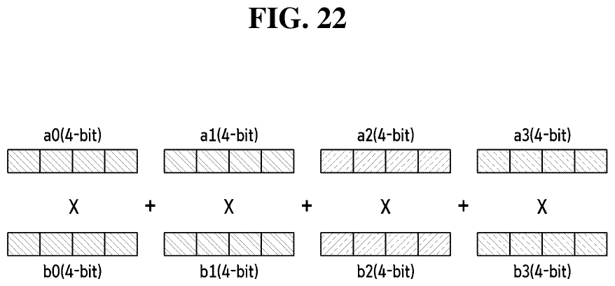

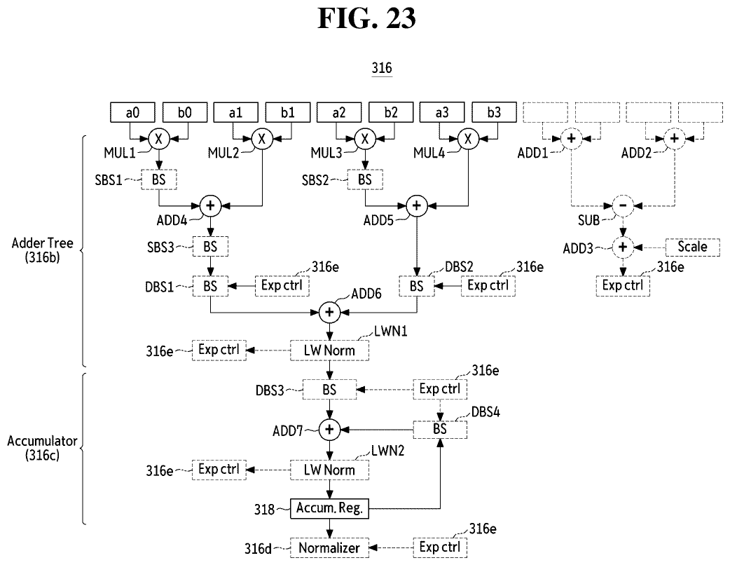

FIG. 22 is a diagram illustrating example INT4-type data. FIG. 23 is a diagram illustrating an ALU 316 that performs an INT4×INT4 operation.

Referring to FIG. 22, INT4-type data may include four data bits a0.

The input allocator 316a of FIG. 6 may divide the 32-bit data into a plurality of operation elements, e.g., a0, b0, a1, b1, a2, b2, a3, and b3, as illustrated in FIG. 22.

The input allocator 316a of FIG. 6 may then provide the divided operation elements to the adder tree 316b, as illustrated in FIG. 23.

Here, the operation elements corresponding to data bits, e.g., a0 and b0, may be provided to the multiplier MUL1, the operation elements corresponding to data bits, e.g., a1 and b1, may be provided to the multiplier MUL2, the operation elements corresponding to data bits, e.g., a2 and b2, may be provided to the multiplier MUL3, and the operation elements corresponding to data bits, e.g., a3 and b3, may be provided to the multiplier MUL4.

The operation of the ALU 316 in the embodiment of FIGS. 22 and 23 is similar to the aforementioned INT operation, and thus, redundant explanations thereof will be omitted. In FIG. 23, the enabled components are indicated with solid lines, while the disabled components are indicated with dotted lines.

The adder tree 316b may perform an INT4×INT4 operation, as illustrated in FIG. 22, using the enabled components in FIG. 23.

The accumulator 316c may add the result from the adder tree 316b to the value stored in the accumulation register 318 using the enabled components in FIG. 23 and store the result of the addition in the accumulation register 318.

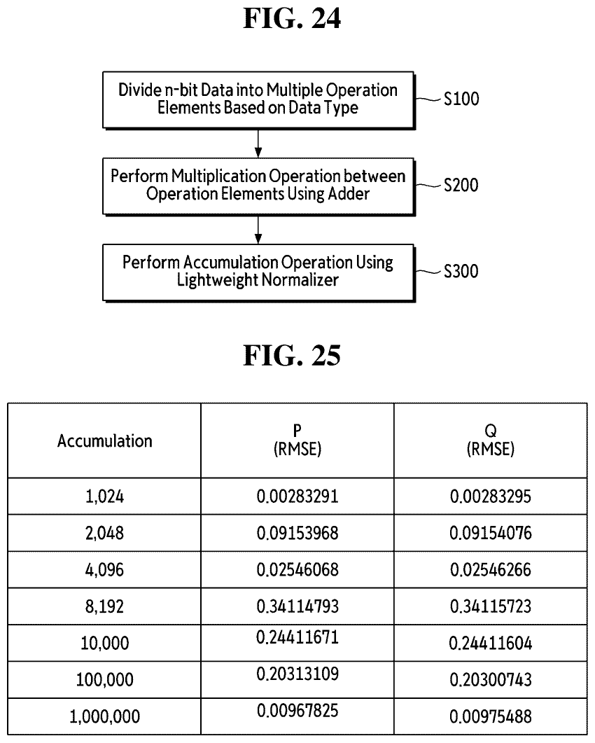

FIG. 24 is a flowchart illustrating a calculation method according to some example embodiments.

Referring to FIG. 24, n-bit input data is divided into a plurality of operation elements based on its data type (S100).

For example, the input allocator 316a of FIG. 6 may divide 32-bit data into a plurality of operation elements based on the data type of the 32-bit data, as described earlier.

Thereafter, a multiplication operation is performed between the operation elements using an adder (S200).

For example, the adder tree 316b of FIG. 6 may perform the multiplication operation between the operation elements in any one of the aforementioned manners.

Thereafter, an accumulation operation is performed using a lightweight normalizer (S300).

For example, the accumulator 316c of FIG. 6 may perform the accumulation operation in any one of the aforementioned manners using the lightweight normalizer.

FIG. 25 is a diagram illustrating the effects of an ALU according to some example embodiments.

FIG. 25 is a table that records changes in Root Mean Square Error (RMSE) obtained by inputting arbitrary data to an ALU (“P”) of the present disclosure and an ALU (“Q”) of FIG. 1 while increasing the number of accumulations. As described earlier, the simulation for the ALU of the present disclosure was performed with conditions of n=32 and m=8, where efficiency was confirmed to be maximized.

Referring to FIG. 25, it can be seen that even as the number of accumulations continuously increases, there is no significant difference in RMSE between the two ALUs, e.g., “P” and “Q.” In other words, the ALU of the present disclosure can perform MAC operations quickly and accurately for various data types.

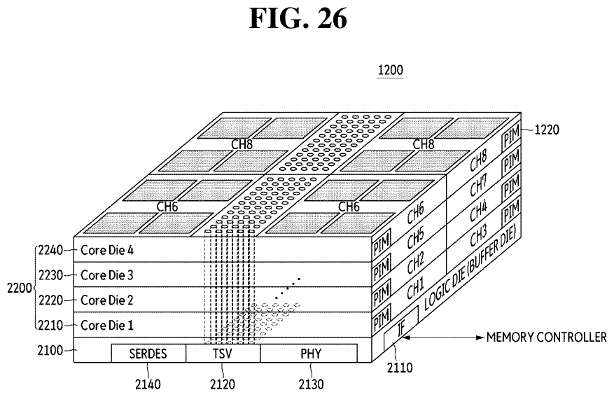

FIG. 26 is a diagram illustrating a memory device according to some example embodiments.

FIG. 26 illustrates an example where the memory device 300 of FIG. 3 is implemented as an HBM. The HBM of FIG. 26 is conceptual, and an actual implementation thereof may vary from the configuration illustrated in FIG. 26.

Referring to FIG. 26, an HBM 1200 may be connected to a host device (e.g., a memory controller “MEMORY CONTROLLER”) via an HBM protocol according to the Joint Electron Device Engineering Council (JEDEC) standard. The HBM protocol is a high-performance random-access memory (RAM) interface for three-dimensional (3D) stacked memories (e.g., DRAMs). Additionally, the HBM 1200 may be connected to the host device via a PIM protocol according to the JEDEC standard.

The PIM protocol is an interface for a PIM device 1220 of the HBM 1200. The HBM 1200 generally achieves a wider bandwidth while consuming significantly less power and occupying a substantially smaller form factor compared to other DRAM technologies (e.g., DDR4, GDDR5, etc.).

The HBM 1200 may include a plurality of channels CH1 through CH8 with independent interfaces and may thus have high bandwidth. The HBM 1200 may include a plurality of dies 2100 and 2200. For example, the HBM 1200 may include a logic die (or buffer die) 2100 and one or more core dies 2200 that are stacked on the logic die 2100.

FIG. 26 illustrates an example where first through fourth core dies 2210 through 2240 are stacked on the HBM 1200, but the number of core dies 2200 may vary. The core dies 2200 may be referred to as memory dies.

Each of the first through fourth core dies 2210 through 2240 may include one or more channels. FIG. 26 illustrates an example where each of the first through fourth core dies 2210 through 2240 includes two channels, resulting in an HBM 1200 with a total of eight channels, e.g., first through eighth channels CH1 through CH8.

For example, the first core die 2210 may include the first and third channels CH1 and CH3, the second core die 2220 may include the second and fourth channels CH2 and CH4, the third core die 2230 may include the fifth and seventh channels CH5 and CH7, and the fourth core die 2240 may include the sixth and eighth channels CH6 and CH8.

The logic die 2100 may include an interface circuit 2110 for communicating with the host device. Through the interface circuit 2110, the logic die 2100 may receive commands, addresses, and data from the host device (e.g., the memory controller 200 of FIG. 3).

The host device (e.g., the memory controller 200 of FIG. 3) may transmit commands, addresses, and data through buses corresponding to the first through eighth channels CH1 through CH8. The buses may be formed to be separated for the first through eighth channels CH1 through CH8, or some of the buses may be shared by at least two of the first through eighth channels CH1 through CH8. The interface circuit 2110 may deliver commands, addresses, and data to the channel where the host device requests a memory operation or arithmetic processing.

In some example embodiments, each of the core dies 2200 or each of the first through eighth channels CH1 through CH8 may include a PIM device 1220.

The host device may provide commands, addresses, and data such that at least some of multiple arithmetic tasks or kernels may be performed in the HBM 1200, and arithmetic processing may be performed in the PIM device 1220 of the channel designated by the host device. For example, when a received command or address instructs arithmetic processing, the PIM device 1220 of the corresponding channel may perform the arithmetic processing using data read from the corresponding channel and write back the result of the arithmetic processing to the corresponding channel. In another example, when the received command or address instructs a memory operation, a data access operation may be performed.

In some example embodiments, each of the first through eighth channels CH1 through CH8 may include a plurality of banks, and the PIM device 1220 of each of the first through eighth channels CH1 through CH8 may be equipped with one or more processing elements, such as the ALU 316 of FIG. 5, as described earlier. For example, the number of processing elements in each of the first through eighth channels CH1 through CH8 may be equal to the number of banks, or if the number of processing elements in each of the first through eighth channels CH1 through CH8 is less than the number of banks, one processing element may be shared by at least two banks. The PIM device 1220 of each of the first through eighth channels CH1 through CH8 may execute the instructions of the kernel offloaded by the host device.

The logic die 2100 may include a Through Silicon Via (TSV) region 2120, an HBM physical layer interface (HBM PHY) region 2130, and a Serializer/Deserializer (SERDES) region 2140.

The TSV region 2120 is or includes an area where TSVs for communication with the core dies 2200 are formed and where the buses corresponding to the first through eighth channels CH1 through CH8 are arranged. If each of the first through eighth channels CH1 through CH8 has, for example, a 128-bit bandwidth, the TSVs may include components for 1024-bit data I/O.

The HBM PHY region 2130 may include a plurality of I/O circuits for communication between the memory controller 200 and the first through eighth channels CH1 through CH8. For example, the HBM PHY region 2130 may include one or more interconnect circuits for connecting the memory controller 200 with the first through eighth channels CH1 through CH8. The HBM PHY region 2130 may include physical or electrical layers and logical layers provided for signals, frequencies, timings, drives, detailed operation parameters, and functionalities required for efficient communication between the memory controller 200 and the first through eighth channels CH1 through CH8. The HBM PHY region 2130 may perform a memory interfacing operation such as selecting rows and columns corresponding to memory cells, writing data to memory cells, or reading data written to memory cells for each of the first through eighth channels CH1 through CH8. The HBM PHY region 2130 may support features of the HBM protocol and/or the PIM protocol according to the JEDEC standard.

The SERDES region 2140 provides a SERDES interface, and in some example embodiments may be according to the JEDEC standard, as the processing throughput of the host device's processors increases and the demands for memory bandwidth increase. The SERDES region 2140 may include a SERDES transmitter section, a SERDES receiver section, and a controller section.

The SERDES transmitter section may include a parallel-to-serial circuit and a transmitter. The SERDES transmitter section may receive a parallel data stream and serialize the received parallel data stream. The SERDES receiver section may include a receiver amplifier, an equalizer, a clock, a data recovery circuit, and a serial-to-parallel circuit. The SERDES receiver section may receive a serial data stream and parallelize the received serial data stream. The controller section may include an error detection circuit, an error correction circuit, and registers such as First In First Out (FIFO), e.g., a queue.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While some example embodiments have been described above with reference to the accompanying drawings, the present disclosure is not limited to the above-described example embodiments and may be embodied in various other forms. Those of ordinary skill in the art will understand that the invention may be implemented in other specific forms without changing the technical spirit or essential features of inventive concept. Therefore, it should be understood that the above-described example embodiments are illustrative in all respects and are not restrictive. Further, example embodiments are not necessarily mutually exclusive with one another. For example, some example embodiments may include one or more features described with reference to one or more figures, and may also include one or more other features described with reference to one or more other figures.

1. A calculation circuit comprising:
an input allocator configured to receive and divide n-bit input data (where n is a natural number equal to or greater than 2) into a plurality of operation elements based on a data type of the input data;
an adder tree configured to perform a multiplication operation between the operation elements; and
an accumulator configured to generate a first output value by adding an output value of the adder tree to a value stored in an accumulation register,
wherein
the first output value includes a sign bit and data bits, and
the accumulator includes a first lightweight normalizer configured to perform bit shifting on the first output value by comparing a value of the sign bit with values of m bits (where m is a natural number greater than, less than, or equal to n) among the data bits.

2. The calculation circuit of claim 1, further comprising:
an exponent controller configured to update an exponential value based on the result of the bit shifting.

3. The calculation circuit of claim 2, further comprising:
a normalizer configured to perform normalization on an output of the accumulator using the exponent controller.

4. The calculation circuit of claim 1, wherein in response to the input data including floating point (FP)-type data, the input allocator is configured to divide exponent bits of the FP-type data into a first operation element, some of data bits of the FP-type data into a second operation element, and other data bits of the FP-type data into a third operation element.

5. The calculation circuit of claim 1, wherein in response to the input data including integer (INT)-type data, the input allocator is configured to divide some of data bits of the INT-type data into a first operation element and other data bits of the INT-type data into a second operation element.

6. The calculation circuit of claim 1, wherein
the operation elements include exponent bits and data bits, and
the adder tree includes a plurality of first adders configured to perform an addition operation on values of the exponent bits, a first subtractor configured to perform a subtraction operation on outputs of the first adders, a plurality of first multipliers configured to perform a multiplication operation on values of the data bits, and a plurality of second adders configured to perform an addition operation on outputs of the first multipliers.

7. The calculation circuit of claim 6, wherein some of the first adders, the first subtractor, the plurality of first multipliers, and the second adders are configured to be disabled, the disabling depending on the data type.

8. The calculation circuit of claim 6, wherein
the data type includes MXINT8, and
the adder tree further includes a third adder configured to add a scale factor of the MXINT8 to an output of the first subtractor.

9. The calculation circuit of claim 6, wherein
the adder tree further includes a plurality of first static bit shifters configured to perform bit shifting on the outputs of the first multipliers by a number of bits, and a plurality of dynamic bit shifters configured to perform bit shifting on the outputs of the second adders based on an output of an exponent controller.

10. The calculation circuit of claim 9, wherein the adder tree further includes a second static bit shifter configured to perform bit shifting on the outputs of the second adders by a number of bits.

11. The calculation circuit of claim 10, wherein the adder tree further includes a third adder configured to perform an addition operation on the outputs of the second adders.

12. The calculation circuit of claim 1, wherein
a result of the multiplication operation between the operation elements includes a sign bit and data bits, and
the adder tree further includes a second lightweight normalizer configured to perform bit shifting on the result of the multiplication operation between the operation elements by comparing a value of the sign bit with values of m bits among these data bits.

13. The calculation circuit of claim 1, wherein the first lightweight normalizer is configured to perform m-bit shifting on the first output value in response to the m bits among the data bits having a same value as the sign bit.

14. The calculation circuit of claim 1, wherein the accumulator further includes a first dynamic bit shifter configured to perform bit shifting on an output of the adder tree based on an output of an exponent controller, a second dynamic bit shifter configured to perform bit shifting on the value stored in the accumulation register based on an output of the exponent controller, and an adder configured to add outputs of the first and second dynamic bit shifters.

15. The calculation circuit of claim 1, wherein n is 32.

16. The calculation circuit of claim 15, wherein m is 8.

17. A memory device comprising:
a memory cell array configured to store data; and
a processing-in-memory (PIM) device configured to be provided with data from the memory cell array and configured to perform an arithmetic operation,
wherein
the PIM device includes an input allocator configured to receive and divide n-bit input data (where n is a natural number equal to or greater than 2) into a plurality of operation elements based on a data type of the input data, an adder tree configured to perform a multiplication operation between the operation elements, and an accumulator configured to generate a first output value by adding an output value of the adder tree to a value stored in an accumulation register,
the first output value includes a sign bit and data bits, and
the accumulator includes a first lightweight normalizer configured to perform bit shifting on the first output value by comparing a value of the sign bit with values of m bits (where m is a natural number greater than n, less than, or equal to n) among the data bits.

18. The memory device of claim 17, wherein the PIM device further includes an exponent controller configured to update an exponential value based on a result of the bit shifting.

19. The memory device of claim 18, wherein the PIM device further includes a normalizer configured to perform normalization on an output of the accumulator using the exponent controller and to output a result of the normalization to the memory cell array.

20. A calculation method comprising:
receiving and dividing n-bit input data (where n is a natural number equal to or greater than 2) into a plurality of operation elements based on a data type of the input data;
performing a multiplication operation between the operation elements using an adder;
generating a first output value including a sign bit and data bits, the generating the first output value performed by adding a value of a result of the multiplication operation to a value stored in an accumulation register; and
performing bit shifting on the first output value by comparing a value of the sign bit with values of m bits (where m is a natural number greater than n, less than n, or equal to n) among the data bits.

21-30. (canceled)
